(19) United States
(12) Patent Application Publication
(10) Pub. No.: US 2007/0289398 A1
(43) Pub. Date: Dec. 20, 2007

(54) Seat Adjusting Device and Method for the Operation Thereof

(76) Inventors: Gerhard Genter, Achern (DE); Guenter Hartz, Buehlertal (DE); Martin-Peter Bolz, Buehl (DE); Hartmut Krueger, Buehlertal (DE); Helmut Bloching, Buehl-Eisental (DE); Lothar Ruff, Buehlertal (DE)

Correspondence Address: MICHAEL J. STRIKER, 103 EAST NECK ROAD, HUNTINGTON, NY, 11743, US

(21) Appl. No.: 11/570,525

(22) PCT Filed: Apr. 28, 2005
(86) PCT No.: PCT/EP05/51942

§ 371 Date: Aug. 10, 2007

(30) Foreign Application Priority Data
Jun. 17, 2004 (DE) 10 2004 029 167.5

(51) Int. Cl. B60N 2/44

(52) U.S. Cl. 74/89

(57) ABSTRACT

Disclosed is a seat adjusting device (10) and a method for operating the same. The seat adjusting device (10) includes two seat parts (15, 16, 17, 18, 19) positioned such that they are movable relative to each other and/or relative to a fastening surface (12, 14) and which are interconnected via at least one ratchet mechanism (56). The ratchet mechanism (56) includes a bidirectionally active rotary drive unit (54) which is operatively connected via a connecting element (52, 64, 72, 78) with at least one pneumatic linear actuator (52) which contracts in an axial direction when acted upon by a certain pressure (42, 43), which causes the rotary drive unit (54) to rotate.

### RELATED ART

The present invention relates to a seat adjusting device, for motor vehicle seats in particular, and a method for the operation thereof, according to the preamble of the independent claims.

Publication DE 100 16 618 A1 makes known a bidirectionally active drive unit for producing a rotary motion which is used to manually adjust a seat in a motor vehicle. With a pivotable driving lever in a zero position, the drive can be selectively rotated in one direction of rotation or the other. The drive unit includes a driven element which is rotated only when the driving lever moves out of the zero position. When the driving lever moves toward the zero position, however, the driven element is not carried along. According to the ratcheting principle, manually produced torque is therefore transmitted to the driven element. The driving lever is returned using a spring element designed as a compression spring.

Publication EP 1209366 B1 makes known a pneumatic actuator which includes an axially and radially elastic tube; when pressure is applied thereto, its diameter increases, which causes it to also shorten in length. This change in length is used to open the hood of a motor vehicle. The disadvantage is that the pneumatic actuator only induces one-time displacement travel, which is the length differential of the tube. With a design of this type, it is also possible to actuate rotation in only one direction (opening the hood) using the pneumatic actuator.

### ADVANTAGES OF THE INVENTION

The inventive seat adjusting device and the method for the actuation thereof with the characterizing features of the independent claims have the advantage that, due to the arrangement of the pneumatic linear actuators on the connecting element of the rotary drive unit, a ratcheting mechanism is automatically actuated, which can actuate a rotary drive unit in both directions. As a result, a seat part or a vehicle seat can be actuated in both directions, e.g., forward and backward, or up and down. Since the linear actuator is coupled to the ratchet mechanism, it is possible to produce rotations at any angle—and, therefore, any extent of displacement of the seat part—by repeatedly actuating the linear actuator. Since a pneumatic pressure supply system is already provided in many motor vehicles as a standard feature, a large number of electric motors is eliminated for the automatic seat adjustment. Due to the flexible tube, pneumatic linear drives of this type must be installed in the seat in a variable manner, and they are lighter in weight than comparable electric motors. Particularly favorably, the inventive pneumatic linear drive can be used for existing seat frames which were previously adjusted manually. A further advantage of the pneumatic linear actuators is the fact that they produce very little noise, which results in increased driving comfort of the motor vehicle.

Advantageous refinements and improvements of the features indicated in the independent claims are made possible by the measures listed in the subclaims. To connect the linear actuators to the rotary drive unit, it is particularly suitable to use a ratchet lever with a free end or a ratchet lever with two diametrically opposed lever arms or movable force-transmission means, such as a toothed belt or a V-belt with two ends.

If the connecting means has two diametrically opposed ends, a pneumatic linear actuator can be advantageously fastened to each end, while the other end of the actuator is fastened to a rigid reference point. When pressure is applied to the actuator, it applies tension force to the connecting means, which causes the rotary drive unit to rotate. The two linear actuators can be positioned nearly parallel, to save space.

When the connecting means includes only one end, e.g., a single-ended ratchet lever, two or more linear actuators can be positioned on this end such that they are diametrically opposed. One of the linear actuators is slackened while the other one contracts. With this design, the linear actuators can be integrated practically directly in a manual ratchet mechanism.

Instead of two pneumatic linear actuators which operate in opposition, one of the two can be replaced with a spring element which brings about the return of the connecting element in opposition to the linear contraction of the one linear actuator. A spring element of this type can be easily adapted to the change in length of the linear actuator and is much less expensive to manufacture than the second linear actuator.

To prevent the rotary drive unit from moving due to the application of torque by the driven side (seat part), the ratchet mechanism has a neutral zero position in which the rotary drive unit is self-locking. Starting in this neutral zero position, the connecting element can be displaced to two different end positions, which results in the rotary drive unit rotating in one direction or the other.

In an alternative embodiment, the ratchet mechanism has only one range of rotation between two end positions. When the connecting element is actuated in one direction, the rotary drive unit is displaced in one direction, and it free-wheels in the opposite direction. The direction of torque transmission with free-wheeling in the opposite direction can be changed mechanically, which allows the one range of rotation to be used to displace the seat parts in opposite directions.

It is particularly favorable to also actuate the torque-transmission direction of the ratchet mechanism using a pneumatic linear actuator which can optionally include an elastic return element.

To actuate the linear actuators, they are connected with a control unit which regulates the application of pressure to the linear actuators using one or more valve units. If larger displacement paths are required to adjust the seat, they can be attained in succession by repeatedly actuating the pneumatic linear actuators. A quasi continual displacement motion can be attained via the frequency with which pressure is applied and the change in length of the linear actuators.

Pressure can be applied to the linear actuators directly from an air pump via connecting lines, or it can be applied by a pressure accumulator which is held at a certain pressure level using a pump. The pressure on the pneumatic linear actuator can be simply released to the surroundings via a valve.

With the method for operating two pneumatic linear actuators which operate in opposition, pressure is applied to the first linear actuator to displace the connecting element in one direction, while pressure is simultaneously released from the second linear actuator. As a result, linear actuators can also be used which apply force to the connecting element only when they contract. The expansion of this linear actuator is subsequently induced via the contraction of the second linear actuator or a spring element which displace the connecting element in the opposite direction.

If two linear actuators designed to operate with alternating timing are located on one connecting element, they can be controlled together using a 4-way/3-position valve; the frequency of the timing change can be specified by the control unit.

As an alternative, the two linear actuators can also connected to the pressure supply unit using two independent 3-way/3-position valves or 3-way/2-position valves.

To actuate the ratchet mechanism with a neutral zero position and two further end positions which correspond to the two directions of rotation, it is particularly suited to control the at least one linear actuator using a pressure-limiting element. It can be used to specify a pressure level to be applied to the linear actuator and which corresponds to a certain linear contraction. The first difference in length between the partially contracted position of the linear actuator and the fully slackened position corresponds to the first ratchet range with a first direction of rotation. When the linear actuator is depressurized, torque is transmitted to the rotary drive unit which free-wheels during subsequent partial contraction.

To actuate the second ratchet range, the maximum pressure—which corresponds to the maximum linear contraction—is applied to the linear actuator. When the pressure is lowered to the preset intermediate pressure, free-wheeling results. It is therefore possible to operate the rotary drive unit in the second direction in this working range.

By using a return element which opposes the linear actuator, a linear actuator can be advantageously used which generates a tension force only when it contracts, since the spring element causes it to expand. Half of all linear actuators, including their pneumatic pressure supply system, can therefore be eliminated for the entire seat.

By controlling the linear actuator using a valve unit which includes a pressure-limiting element, a defined partial contraction of the linear actuator can be attained without the use of electronic pressure regulation. A set amount of pressure can therefore be restored exactly, even when pressure is applied frequently, without the need to use a pressure sensor.

### DRAWING

Several exemplary embodiments of inventive seat adjusting devices are presented in the drawing and are described in greater detail in the description below.

FIG. 1 shows a schematic view of the seat adjustment functions,

FIG. 2 shows a pneumatic linear actuator,

FIG. 3 shows an inventive ratchet device with two ranges of rotation,

FIG. 4 shows an inventive ratchet mechanism with a switchable torque-transmission direction,

FIGS. 5a) through 5c) show various inventive arrangements of linear actuators on a connecting element,

FIGS. 6a) through 6c) depict variations of the arrangements shown in FIGS. 5a) through 5c) with return springs,

FIG. 7 shows a control system for an inventive displacement function,

FIG. 8 shows an alternative valve system compared with the exemplary embodiment depicted in FIG. 7, and

FIG. 9 shows a further variation of an inventive seat adjusting device.

### DESCRIPTION OF THE EXEMPLARY EMBODIMENTS

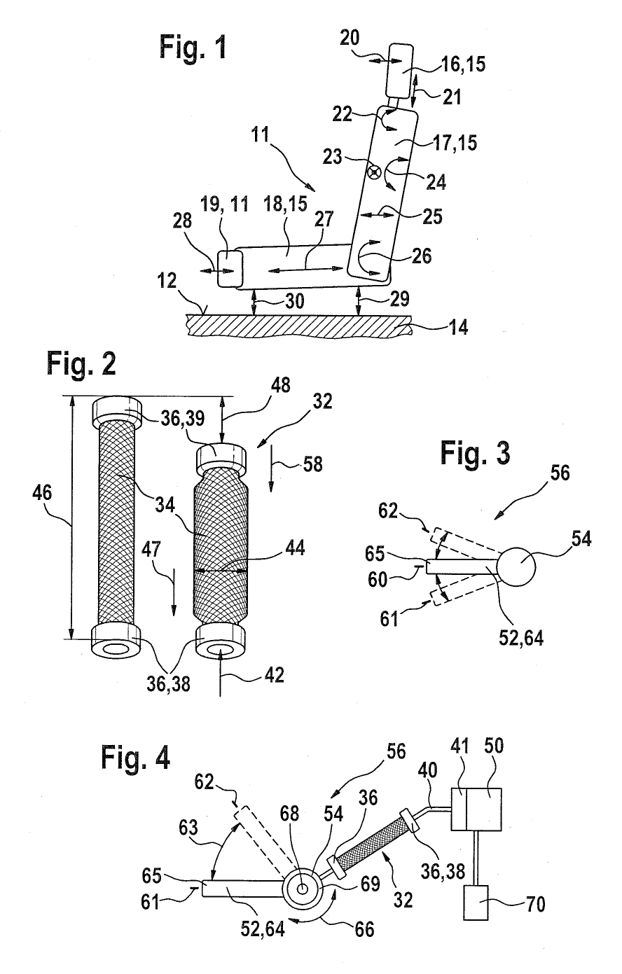

FIG. 1 shows a vehicle seat 11 which is fastened to a fastening surface 12 of a body 14. Seat 11 includes various seat parts 15, e.g., head restraint 16, backrest 17, seat surface 18, or seat extension 19. Seat parts 15 are located such that they are movable relative to each other using inventive seat adjusting device 10. Seat 11 can also be moved in entirety relative to fastening surface 12. The adjustment functions according to the present invention relate specifically to head restraint linear position 20, head restraint height 21, head restraint tilt 22, backrest width 23, backrest pillow position 24, lordosis support 25, backrest tilt 26, seat length position 27, seat depth 28, seat height 29, and seat tilt 30.

Seat parts 15 and seat 11 are displaced using pneumatic linear actuators 32 as are shown in FIG. 2. Linear actuator 32 includes a flexible tube 34, on both ends of which end pieces 36 are located. An end piece 36 forms a connector 38 for pneumatic supply lines 40. When a certain pressure 42 is applied to linear actuator 32 via connector 38, tube 34 contracts, thereby resulting in the simultaneous expansion of its diameter 44. Air is used, for example, as the medium for generating pressure 42; it is compressed using a pump 50. In the slack state, linear actuator 32 has a maximum length 46, which is reduced by a change in length 48 along an axial direction 47 when pressure is applied. Depending on what material is used to make flexible tube 34, change in length 48 can be up to 25 percent of maximum length 46. If connecting piece 38 is fixedly attached to seat part 15, diametrically opposed end piece 36 exerts a tension force 58 on connecting element 52 which is connected thereto. Second end piece 36, which is diametrically opposed to connector 38, is designed as a pressure-tight fastening element 39, which is connected, e.g., with connecting means 52 of a rotary drive unit 54, as shown in FIG. 3.

FIG. 3 shows a rotary drive unit 54 which is connected with a ratchet mechanism 56 and is located, e.g., between seat parts 15 which are located such that they are movable relative to each other. Ratchet mechanism 56 has a neutral rest position 60 in which the two seat parts 15 are locked fixedly in position relative to each other.

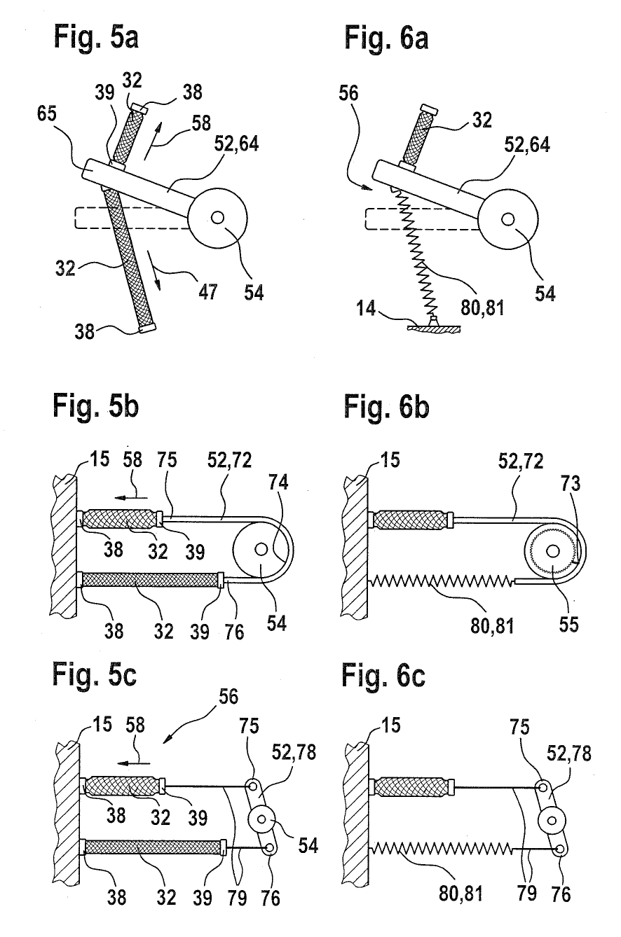

Connecting element 52 is designed as a ratchet lever 64 with a free end 65 which, according to the embodiment shown in FIG. 5a), is connected with pneumatic linear actuators 32. When connecting element 52 is moved into a first end position 61, torque is transmitted to a seat part 15 via a driven element 55 of rotary drive unit 54, or force is transmitted thereto via downstream displacement kinematics. According to the ratchet principle, ratchet mechanism 56 free-wheels when connecting element 52 is returned from first end position 61 to rest position 60. Torque is therefore not transmitted when ratchet lever 64 is returned. This procedure can be repeated as many times as necessary using the at least one linear actuator 32 until seat part 15 reaches the desired position. If the intention is to return seat part 15 in the opposite direction, connecting element 52 is moved from neutral rest position 60 to second end position 62. Torque for rotary drive unit 54 is transmitted in the opposite direction, and free-wheeling occurs upon return from second end position 62 to neutral rest position 60. With a design of this type, neutral rest position 60 ensures that the system is always mechanically self-locking when torque or force is applied by seat parts 15 to rotary drive 54.

FIG. 4 shows an alternative design of a ratchet mechanism 56, with which connecting element 52 can only be moved within a single range of rotation 63 between a first and second end position 61, 62. Rotary drive unit 54 also includes a free-wheeling device, thereby ensuring that torque is not transmitted when ratchet lever 64 is returned from second end position 62 to first end position 61. Since this device does not have a neutral rest position 60, torque-transmission direction 66 must be switched over using a switch 68 on rotary drive unit 64. The self-locking function of the system is carried out, e.g., using a load moment lock 69. In the exemplary embodiment depicted in FIG. 4, torque-transmission direction 66 is also switched using a pneumatic linear actuator 32 which is connected via pneumatic supply lines 40 and a valve unit 41 with pump 50. Seat adjusting device 10 includes a control unit 70 which controls the activation of linear actuators 32 of ratchet lever 64 and switch 68.

Various exemplary embodiments of a seat adjusting device 10 are depicted in FIGS. 5a) through 5c). In each case, two pneumatic linear actuators 32 are positioned such that they oppose each other. In FIG. 5a), connecting element 52 is designed—as it is in FIG. 3—as a ratchet lever 64 with a free end 65 at which the two linear actuators 32 are fastened in a diametrically opposed manner with fastening elements 39. Pneumatic supply lines 40 which are connected with connectors 38 are not shown in greater detail here. When linear actuators 32 are activated, they exert a tension force 58 along axial direction 47 toward connecting element 52. In FIG. 5b), connecting element 52 is depicted as a flexible traction mechanism 72 which interacts via a form-fit connection 73 or a frictional connection 74 with rotary drive unit 54. Traction mechanism 72 includes two free ends 75, 76 which are connected with end pieces 36 of linear actuators 32, end pieces 36 being designed as fastening elements 39. Linear actuators 32 are fixedly connected via the other end pieces 36—which are designed as connectors 38—with a seat part 15, e.g., backrest 17. Rotary drive unit 54, however, is connected via driven element 55 with a second seat part 15, e.g., head restraint 16. The rotary motion of rotary drive unit 54 can be used directly to adjust head restraint tilt 52, or it can be converted to a head restraint height adjustment 21 using a not-shown gearbox, e.g., a spindle gearbox. In FIG. 5c), instead of traction mechanism 72, a rigid ratchet lever 78 with two radially opposed free ends 75, 76 are connected with rotary drive unit 54 in accordance with the ratchet principle. Flexible coupling elements 79 are located between fastening elements 39 of linear actuators 32 and free ends 75, 76 in order to couple the rotary motion of ratchet lever 78 with the linear motion of pneumatic linear actuators 32.

FIGS. 6a) through 6c) each show variations of the exemplary embodiments depicted in FIGS. 5a) through 5c). In each case, a linear actuator 32 is replaced with an elastic return element 80. Return element 80—as is linear actuator 32—is fixedly attached to a seat part 15 at one end and with connecting element 52 at the other end. Rest element 80 is designed, e.g., as a tension spring 81 which exerts a tension force 58 on its fastening element 39. When linear actuator 32 is depressurized, tension force 58 of spring element 80 causes rotary drive unit 54 to be returned via the free-wheeling mechanism and optionally causes linear actuator 32 to extend to its maximum length. Exemplary embodiments depicted in FIGS. 5a) through 5c), and exemplary embodiments depicted in FIGS. 6a) through 6c) can be operated according to the ratchet principle depicted in FIG. 3 with a neutral rest position 60, or according to the ratchet principle depicted in FIG. 4 with a single range of rotation 63 without a self-locking rest position 60.

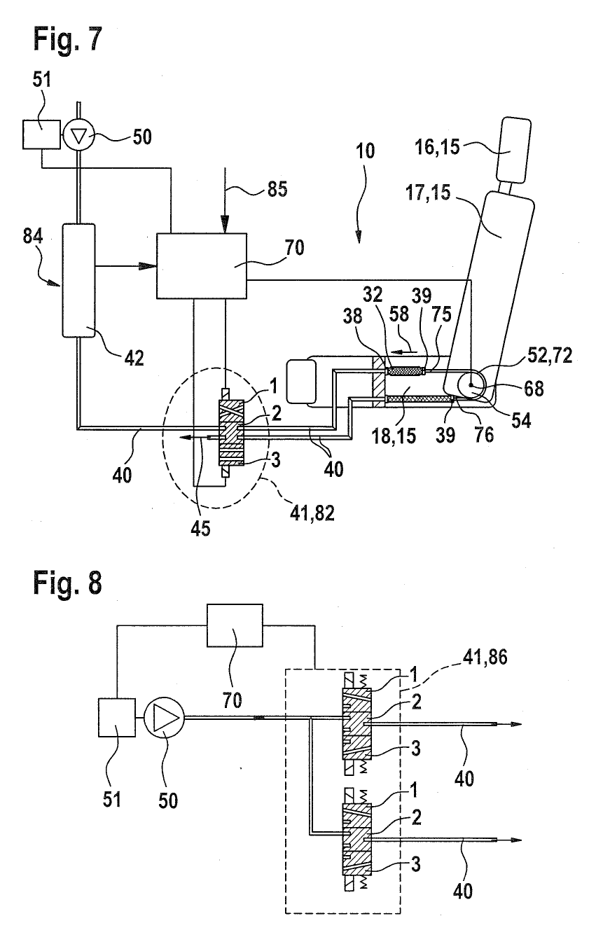

A method for operating a seat adjusting device 10 based on the exemplary embodiment shown in FIG. 5b) with a ratchet mechanism 56 without a neutral rest position 60 (FIG. 4) is depicted with reference to FIG. 7. The two connectors 38—which are fixedly connected to seat surface 18 as seat part 15 in this case—are connected via pneumatic supply lines 40 with valve unit 41. Valve unit 41 is designed as a 4-way/3-position valve 82 (“4/3 valve”), to which both linear actuators 32 are connected. In valve position 2 shown, pressure 42 in both linear actuators 32 remains unchanged, so that seat parts 15 are not changed at this time. Valve unit 41 is connected via a pressure accumulator 84 with pump 50. A pump motor 51—as is valve unit 41—is controlled by control unit 70. When control unit 70 receives a displacement signal 85, it switches valve unit 41 such that maximum pressure 42 is applied to one of the linear actuators 32, and the other linear actuator 32 is depressurized via the release of compressed air to surroundings 45. In FIG. 7, when valve 41 is displaced upwardly (valve position 3), for example, pressure 42 is applied to upper linear actuator 32. This linear actuator 32 contracts by change in length 48, so that tension force 58 acts via connecting element 52 on rotary drive unit 54 and torque is transmitted to driven element 55. After maximum contraction of upper linear actuator 32, control unit 70 switches valve 41 entirely downwardly (valve position 1), so that upper linear actuator 32 is now completely depressurized, while maximum pressure 42 is simultaneously applied to lower linear actuator 32. Lower linear actuator 32 contracts by change in length 48, while upper linear actuator 32 is completely released. According to the ratchet principle, the free-wheeling mechanism functions in this direction of rotation of rotary drive unit 54. Torque is therefore not transmitted to driven element 55. Control unit 70 now prescribes the frequency at which valve positions 1 and 3 are switched. Changes in length 48 of linear actuators 32 can also be influenced via the period of time for which pressure is applied. Since linear actuators 32 are vented to the surroundings 45, control unit 70 ensures that a certain pressure level 42 is always maintained in pressure accumulator 84 via pump motor 51. If the intention is to reverse the adjustment direction of seat parts 15, control unit 70 initiates actuation of switch 68 to reverse torque-transmission direction 66. This takes place, e.g., using a further linear actuator 32 according to the embodiment depicted in FIG. 4.

FIG. 8 shows an alternative valve arrangement 41 for the exemplary embodiment according to FIG. 7, although the 4/3 valve is replaced with two independent 3/3 valves. Pressure can be applied to the two linear actuators 32 independently, or they can be vented independently, via control unit 70. The coordination and cycle time of the two independent 3/3 valves 86 takes place exclusively via control unit 70. In this variation, valve unit 41 is supplied with compressed air directly by pump 50, and control unit 70 regulates the desired pressure requirement. In an alternative embodiment, 3/2 valves can be used instead of 3/3 valves 86. In this case, the supply of compressed air (valve position 2) to the two linear actuators 32 is not interrupted.

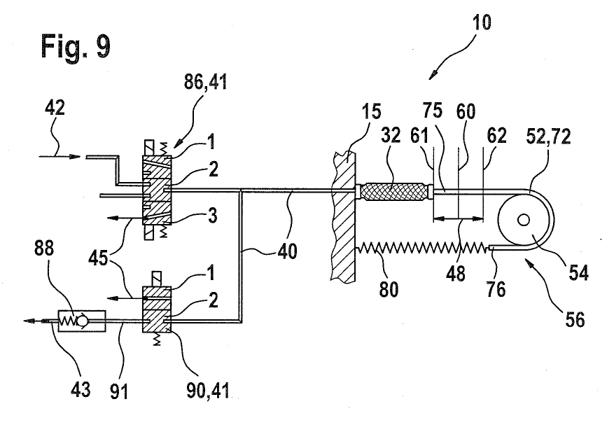

A further method for operating a seat adjusting device 10 based on the exemplary embodiment shown in FIG. 6b) and a ratchet mechanism 56 without a neutral rest position 60 (FIG. 3) is described with reference to FIG. 9. Connecting element 52 is connected via its first end 75 with only one pneumatic linear actuator 32 and via the other free end 76 with a return spring 80. Since rotary drive unit 54 is locked in neutral rest position 60, linear actuator 32 is operated in different pressure ranges for both torque-transmission directions 66. This results in a different change in length 48 of linear actuator 32. To ensure that neutral rest position 60 can be maintained, a certain length of linear actuator 32 must be set, e.g., maximum length 46 is reduced by half of maximum change in length 48. At this length, linear actuator 32 is only partially contracted; this corresponds to a certain pressure level 43 which is set using a pressure-limiting unit 88 coupled with valve unit 41. Connector 38 is connected via a 3/3 valve 86 with a pressure supply system 84. Located in parallel with 3/3 valve 86 is a further valve 90, e.g., a 2/2 valve, the vent outlet 91 of which is connected with pressure-limiting unit 88. If an actuating signal 85 is not supplied to control unit 70, both valves 86 and 90 are located in a locked position (valve position 2) in which the current pressure is maintained. If the intention is to lift a seat part 15, for example, this corresponds to moving connecting element 52 from neutral position 60 into first end position 61. To accomplish this, linear actuator 32 must contract, for which 3/3 valve 86 must be switched downwardly (valve position 1), in order to apply maximum pressure 42. At the same time, lower 2/2 valve 90 is locked (valve position 2), so that maximum pressure 42 builds up in linear actuator 32 with a maximum contraction 48. For the free-wheeling motion from end position 61 into neutral rest position 60, linear actuator 32 must expand back to its neutral position 60. To this end, valve 86 is in locking valve position 2, while 2/2 valve 90 releases pressure 42 against pressure-limiting element 88 (valve position 1), by way of which pressure level 43 of pressure-limiting element 88 is adjusted in linear actuator 32. This procedure can be repeated as often as necessary to lift seat part 15.

If the intention is to move seat part 15 in the opposite direction, e.g., to lower it, connecting element 52 must be moved from neutral rest position 60 to second end position 62. To this end, linear actuator 32 must expand to a maximum extent. To this end, valve 86 vents linear actuator 32 (valve position 3) to surroundings 45. Return element 80 contributes to this venting of linear actuator 32. Linear actuator 32 must contract partially once more to attain the free-wheeling motion from end position 62 to neutral rest position 60. To this end, valve 90 remains in pressure-limiting position (valve position 1), and valve 86 is switched to valve position 1 for a definite period of time, so that maximum pressure 42 is applied here. As a result, a level of pressure builds up in linear actuator 32, which corresponds to pressure level 43 of pressure-limiting unit 88. As a result, fastening element 39—with end 75 of connecting element 52—moves into neutral rest position 60. This cycle can also be repeated until seat part 15 is lowered per command 85. With this exemplary embodiment with traction means 72 as connecting element 52, it is only possible for pneumatic linear actuator 32 to transmit tension forces 58 to rotary drive unit 54. A linear actuator 32 can therefore also be used which, e.g., produces a displacement force only when it contracts, and which is expanded using corresponding return spring 80 or via a second linear actuator 32 as depicted in FIG. 7.

It should be noted that, with regard for the exemplary embodiments presented in the figures and the description, many different combinations of the individual features and method steps are possible. For example, the specific arrangement and design of seat parts 15 relative to each other, of rotary drive unit 54 and connecting elements 52, and the arrangement of linear actuators 32 and elastic return elements 80 can be varied. Likewise, ratchet mechanism 56 can be modified in terms of its neutral zero position 60 and the direction of the free-wheeling rotation, or its change of direction. The inventive seat adjusting device is particularly suited for the modification of a manual ratchet mechanism 56 with a locking neutral rest position and the optional use of elastic return elements 80. The pneumatic displacement device can also be combined, very favorably, with a pneumatic massage or vehicle dynamics system.

What is claimed is:

1. A seat adjusting device (10)—for motor vehicle seats in particular—with two seat parts (15, 16, 17, 18, 19) positioned such that they are movable relative to each other and/or relative to a fastening surface (12, 14) and which are interconnected via at least one ratchet mechanism (56) which includes a bidirectionally active rotary drive unit (54),
wherein
the rotary drive unit (54) is operatively connected via a connecting element (52, 64, 72, 78) with at least one pneumatic linear actuator (52) which contracts in an axial direction when acted upon by a certain pressure (42, 43), which causes the rotary drive unit (54) to rotate.

2. The seat adjusting device (10) as recited in claim 1,
wherein
the connecting element (52) is designed as a single-ended ratchet lever (64) or as a double-ended ratchet lever (78) or as a traction mechanism (72), e.g., a toothed belt (72) or a chain (72).

3. The seat adjusting device (10) as recited in claim 1,
wherein
the connecting element (52) has diametrically opposed ends (75, 76) on each of which at least one pneumatic linear actuator (32) is located; several pneumatic linear actuators (32) are preferably positioned nearly parallel in the axial direction (47).

4. The seat adjusting device (10) as recited in claim 1,
wherein
at least two pneumatic linear actuators (32) are located on one end (65) of the connecting element (52); the two linear actuators (32) oppose each other when they contract linearly.

5. The seat adjusting device (10) as recited in claim 1,
wherein
an elastic return element (80) is located on the connecting element (52)—particularly at one end (65, 75, 76) thereof—which opposes the linear contraction of the at least one pneumatic linear actuator (32).

6. The seat adjusting device (10) as recited in claim 1,
wherein
the ratchet mechanism (56) has a neutral rest position (60) in which the movement of the seat parts (15) is blocked, and two end positions (61, 62) for the two rotary directions (66); the rotary drive unit (54) in particular rotates only in the particular direction of rotation (66) when the connecting element (52) is moved out of the rest position (60), while the rotary drive unit (54) does not rotate when the connecting element (52) moves toward the rest position (60).

7. The seat adjusting device (10) as recited in claim 1,
wherein
the ratchet mechanism (56) has only one range of rotation (63) with a free-wheeling device, the torque-transmission direction (66) of which is switchable using a switch (68).

8. The seat adjusting device (10) as recited in claim 1,
wherein
the torque-transmission direction (66) of the ratchet mechanism (56) is switchable using at least one pneumatic linear actuator (32) and/or the elastic return element (80).

9. The seat adjusting device (10) as recited in claim 1,
wherein
the at least one pneumatic linear actuator (32) is connected via a valve system (41, 82, 86, 90) with a pressure supply system (84, 50) and an electronic control unit (70) in order to apply a certain pressure (42, 43) to the at least one pneumatic linear actuator (32) with a specifiable frequency and in an alternating manner, and to subsequently depressurize it.

10. The seat adjusting device (10) as recited in claim 1,
wherein
the pressure supply system (84, 50) includes a pump motor (51) and/or a pressure accumulator (80) which are connected via one or more valve units (41, 82, 86, 90) with the at least one pneumatic linear actuator (32).

11. A method for operating a seat adjusting device (10)—according to claim 1, in particular—which includes two seat parts (15, 16, 17, 18, 19) positioned such that they are movable relative to each other and/or relative to a fastening surface (12, 14) and which are interconnected via at least one ratchet mechanism (56) which includes a bidirectionally active rotary drive unit (54) which is operatively connected via a connecting element (52, 65, 72, 78) with at least two opposing pneumatic linear actuators (32) which are controlled such that the first pneumatic linear actuator (32) contracts in an axial direction when acted upon by a certain pressure (42, 43), while the second pneumatic linear actuator (32) expands when it is depressurized.

12. The method as recited in claim 11,
wherein
two pneumatic linear actuators (32) are controlled together using a 4-way/3-position valve unit (41, 82).

13. The method as recited in claim 11,
wherein
the individual pneumatic linear actuators (32) are each controlled using an independent 3-way/3-position valve unit (41, 86) or a 3-way/2-position valve unit (41).

14. The method for operating a seat adjusting device (10)—according to claim 1, in particular—which includes two seat parts (15, 16, 17, 18, 19) positioned such that they are movable relative to each other and/or relative to a fastening surface (12, 14) and which are interconnected with a rotary drive unit (54) via at least one ratchet mechanism (56) which has a neutral rest position (60) in which the movement of the seat parts (15, 16, 17, 18, 19) is blocked, and two end positions (61, 62) for the two directions of rotation (66), and the rotary drive unit (54) is operatively connected with at least one pneumatic linear actuator (32) which is controlled such that, for one direction of rotation (66), the pneumatic linear actuator (32) expands and contracts between its minimal length and a portion—half, in particular—of its maximum length (46), while, for the opposite direction of rotation (66), the pneumatic linear actuator (32) expands and contracts between the portion—half, in particular—of its maximum length (46) and its maximum length (46).

15. A method for operating a seat adjusting device (10)—according to claim 1, in particular—which includes two seat parts (15, 16, 17, 18, 19) positioned such that they are movable relative to each other and/or relative to a fastening surface (12, 14) and which are interconnected via at least one ratchet mechanism (56) which includes a bidirectionally active rotary drive unit (54) which is operatively connected via a connecting element (52, 65, 72, 78) with at least one pneumatic linear actuator (32) and an opposing elastic return element (80) which absorbs potential energy while the pneumatic linear actuator (32) is acted upon by a certain pressure (42, 43) and releases potential energy in order to expand the pneumatic linear

16. The method as recited in claim 11,
wherein
the at least one pneumatic linear actuator (32) is operated with a pressure-limiting element (88) to adjust a specifiable linear expansion (48).
